(19) United States
(12) Patent Application Publication
(10) Pub. No.: US 2023/0286451 A1
(43) Pub. Date: Sep. 14, 2023

(54) VEHICLE INTERFACE SYSTEM AND/OR METHOD

(71) Applicant: Terraline, Inc., Fremont, CA (US)

(72) Inventors: Andreas Bauer, Fremont, CA (US); Graham Doorley, Fremont, CA (US); Eric Canonge, Fremont, CA (US); Kyle Motter, Fremont, CA (US); Julian Lemus, Fremont, CA (US); Mengwei Campbell, Fremont, CA (US)

(21) Appl. No.: 18/116,230

(22) Filed: Mar. 1, 2023

Related U.S. Application Data
(60) Provisional application No. 63/315,491, filed on Mar. 1, 2022.

(51) Int. Cl. B60R 16/023; B60W 60/00; G06F 9/54

(52) U.S. Cl. CPC B60R 16/0231; B60W 60/001; G06F 9/542; B60W 2556/45

(57) ABSTRACT

The system 100 can include: a vehicle platform 110; a vehicle interface 120; and/or any other suitable components. The system 100 can optionally include driver system 130, an auxiliary sensor payload 140, a logger 150, and/or any other suitable components. However, the system 100 can additionally or alternatively include any other suitable set of components. The system functions to facilitate control of the vehicle platform based on driver inputs received at the vehicle interface. Additionally or alternatively, the system can function to facilitate installation and/or operation of a driver system (e.g., such as an AI driver or autonomous agent; modular driver system) and/or an auxiliary sensor payload onboard the vehicle platform. However, the system 100 can have any other suitable functionality.

### CROSS REFERENCE TO RELATED APPLICATIONS

This application claims the benefit of U.S. Provisional Application No. 63/315,491, filed 01-MAR-2022, which is incorporated herein in its entirety by this reference.

### TECHNICAL FIELD

This invention relates generally to the vehicle controls field, and more specifically to a new and useful vehicle interface system and/or method in the vehicle controls field.

### BRIEF DESCRIPTION OF THE FIGURES

FIG. 1A is a schematic representation of a variant of the system.

FIG. 1B is a schematic representation of a variant of the system.

FIG. 2 is a schematic representation of a variant of the system, illustrating multiple vehicle drivers.

FIG. 3 is a schematic representation of a variant of the system.

FIG. 4 is a schematic representation illustrating infrastructure connections for a variant of the system.

FIG. 5 is a flow chart diagrammatic representation of a variant of the method.

FIG. 6 is an illustrative example of a system architecture.

FIG. 7A is a schematic representation of a variant of the system.

FIG. 7B is a schematic representation of a variant of the system.

FIG. 8 is a diagrammatic representation of process flow between system elements in a variant of the system and/or method.

FIG. 9 is a diagrammatic representation of process flow between system elements in a variant of the system and/or method.

FIG. 10 is a diagrammatic representation of process flow between system elements in a variant of the system and/or method.

FIG. 11 is a schematic example of a variant of the system.

FIG. 12 is a 3D view with a cross-sectional illustration of an example mount structure for an auxiliary sensor payload in a variant of the system.

### DESCRIPTION OF THE PREFERRED EMBODIMENTS

The following description of the preferred embodiments of the invention is not intended to limit the invention to these preferred embodiments, but rather to enable any person skilled in the art to make and use this invention.

### 1 Overview

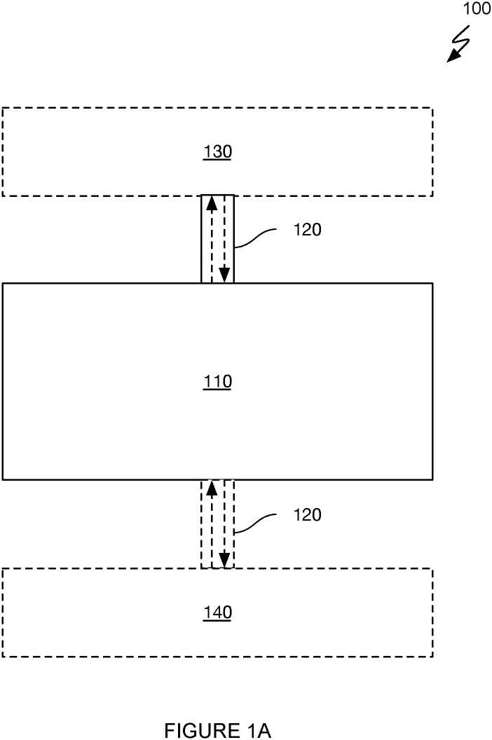

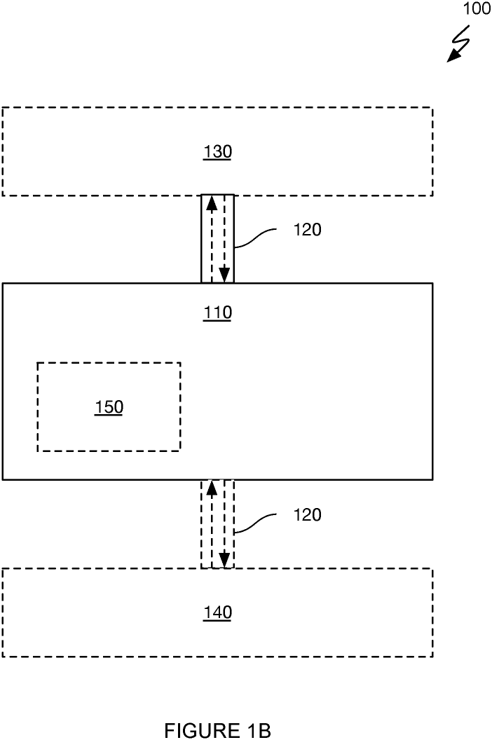

The system 100, an example of which is shown in FIG. 1A, can include: a vehicle platform 110; a vehicle interface 120; and/or any other suitable components. The system 100 can optionally include driver system 130, an auxiliary sensor payload 140, a logger 150, and/or any other suitable components. However, the system 100 can additionally or alternatively include any other suitable set of components. The system functions to facilitate control of the vehicle platform based on driver inputs received at the vehicle interface. Additionally or alternatively, the system can function to facilitate installation and/or operation of a driver system (e.g., such as an AI driver or autonomous agent; modular driver system) and/or an auxiliary sensor payload onboard the vehicle platform. However, the system 100 can have any other suitable functionality.

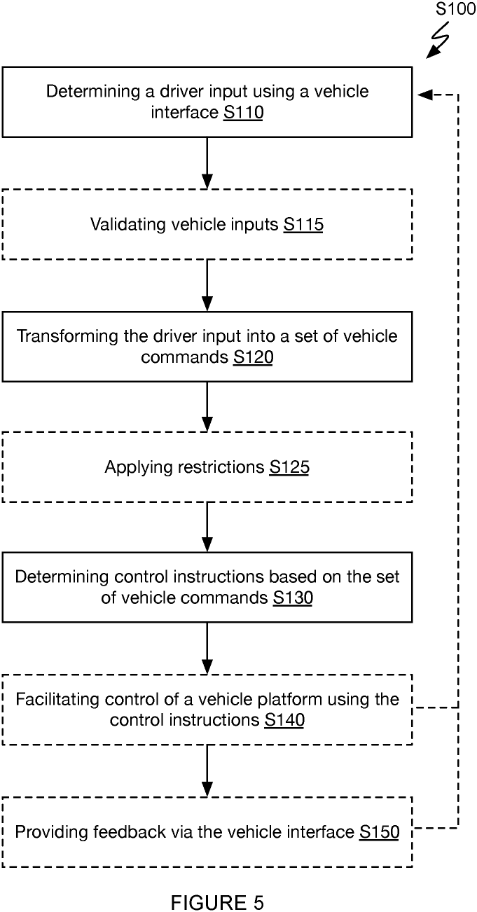

The method S100, an example of which is shown in FIG. 5, can include: determining a driver input using a vehicle interface S110; transforming the driver input into a set of vehicle commands S120; and determining control instructions based on the set of vehicle commands S130. The method S100 can optionally include: validating vehicle inputs S115; applying restrictions S125; facilitating control of a vehicle platform using the control instructions S140; and providing feedback via the vehicle interface S150. However, the method S100 can additionally or alternatively include any other suitable elements. The method S100 can function to facilitate control of a vehicle platform using a driving system (e.g., AI driver).

In variants, the system and/or method can facilitate “plug-and-play” Drive-by-Wire (DBW) control of a vehicle via a unified interface (e.g., the vehicle interface 120), with all control communication provided via a unified I/O connection (e.g., a single I/O plug; which may be redundant) and/or a unified software interface (e.g., with the unified I/O and other vehicle resources available in a single enclosure/housing).

The term “platform” as referenced herein, in the context of the “vehicle platform” or otherwise, can refer to a foundational framework (e.g., including hardware and/or software elements) upon which other technologies can be implemented. For example, a driver system(s) can be built upon and/or (modularly) integrated with the vehicle platform via a vehicle interface. However, the terms platform and/or vehicle platform can be otherwise suitably utilized or referenced herein.

The term “substantially” as utilized herein can mean: exactly, approximately, within a predetermined threshold or tolerance, and/or have any other suitable meaning.

### 1.1 Illustrative Examples.

In human-operated vehicle systems, a human driver may conventionally operate a vehicle by providing manual inputs for an array of input axes (e.g., steering position, gas pedal position, brake pedal position, etc.). In drive-by-wire architectures, these inputs can be parameterized, and the resulting parameter values may be used at various electronic control units (ECUs), distributed throughout the vehicle, to generate low-level instructions used to control vehicle systems (e.g., brakes, etc.).

In one variant, an autonomous agent can be implemented in an existing drive-by-wire vehicle architecture by generating a vehicle-specific model of the resulting communication network (e.g., reverse engineering communications throughout the system) and using this model to generate the necessary communications/messaging to execute autonomously-generated vehicle instructions. Additionally or alternatively, in this variant, the autonomous agent can directly communicate with a set of ECUs and/or control modules distributed throughout the vehicle. However, this approach may not be resilient to changes in the vehicle components/architecture, and thus may “tie-in” an autonomous agent to a particular vehicle platform with a specific set of components and/or a set of corresponding communication protocols. Even in cases where the communication architecture is predetermined (e.g., provided by a vehicle supplier or OEM) and used by an autonomous agent, the step of translating high-level driver decisions (e.g., corresponding to the manual input axes; throttle and braking inputs) into this low-level messaging can be a significant hindrance to deployment of an autonomous computing system (e.g., increasing system complexity, increasing certification/regulatory burden, engineering effort, etc.). As an example: in such architectures, autonomous computing systems may be considered the responsible authority for managing both the driver decisions (and associated driver inputs, such as a braking input, steering angle, etc.) and the distribution of resulting communications throughout a vehicle communication network (e.g., CAN, LIN, etc.) based on the driver decisions. Further, autonomous computing systems may also be responsible for implementing (or managing the control hand-offs/arbitration between) various Advanced Driver-Assistance Systems (ADAS), in conjunction with autonomous control, which may also be highly specific to a particular vehicle or vehicle configuration (e.g., where arbitration/authority rules may be specific to a vehicle configuration).

In an alternative set of variants, a vehicle which is manufactured to be controlled at least partially autonomously can include a vehicle interface which receives high-level driver inputs (e.g., in a digital format; in a uniform/standardized format and via a predetermined/singular communication protocol; etc.) from an autonomous agent, where the vehicle interface manages the resulting messaging and distributed vehicle communication associated with the driver inputs. In this set of variants, the autonomous agent can be responsible for driver decisions without handling distributed vehicle messaging, control, execution, and/or verification against a predefined safety or automation protocol (e.g., such as may be used for ABS, ASR, ESP, etc.; where arbitration between one or more sets ‘driver inputs’ and driver assistance systems, such as ADAS, may be fully decoupled from the driver system and/or processing thereof). In such variants, the autonomous agent can be modular and/or independent of the vehicle components, communication network architecture, and/or the set of corresponding communication protocols. For example, updates to vehicle components (e.g., ECUs, computing architecture, etc.) and the communication network architecture (e.g., communication protocols; models for communications, control arbitration, and/or driver priority/authority; etc.) may occur: without modification to driver system (e.g., autonomous agent), without modification to the driver side of the vehicle interface (e.g., driver-side portion of the SW interface and/or API), and/or without modification to the communication protocol/architecture utilized by the driver system (e.g., to communicate with the vehicle interface and/or API).

In one example, a dedicated I/O port (and/or controller) for the driver system, which provides access to the low-level communication network (e.g., various CAN Buses), can be built into the base vehicle platform, while relying on a J1939 communication protocol. However, for multiple systems to work simultaneously in this example may still require managing signal prioritization (e.g., because CAN buses rely on a single circuit).

In one example, the vehicle interface may provide an intervening layer so that the driver systems (e.g., AI driver, tele-op driver, autonomous fallback driver, etc.) may utilize a different communication protocol (e.g., no longer required to utilize the J1939 signals) and can instead use a simplified interface.

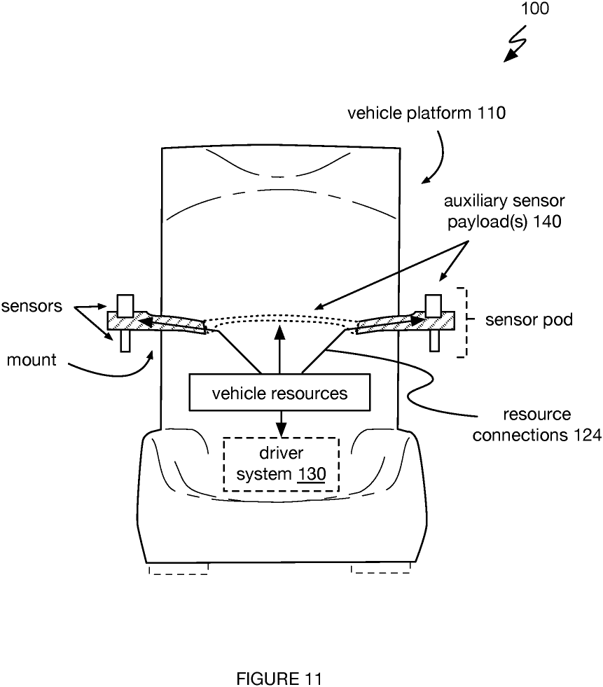

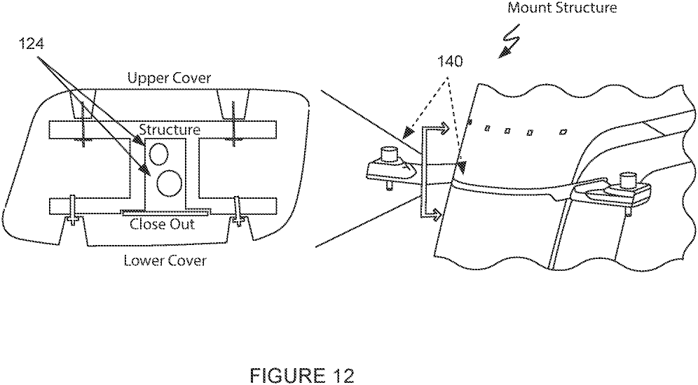

In one example, the vehicle interface may allow sensor sampling rates and data transfer volumes (e.g., between the autonomous agent and the auxiliary sensor payload) which may far exceed the capability of low-level messaging platforms and corresponding messaging protocols (e.g., CAN). For instance, a Controller Area Network (CAN) may have a maximum data rate (i.e., number of bits transmitted per second) of 1 Mbit/s and CAN Flexible Data-Rate (FD) may have a maximum data rate of 5 to 8Mbit/s (e.g., for the data payload only; the arbitration bit rate may still be limited to 1Mbit/s). Conversely, the vehicle interface may utilize a separate communication protocol (e.g., integrated into the physical structure of the vehicle; Ethernet; Gigabit Ethernet; EoC; etc.) to facilitate communication at higher data rates between driver system(s) and onboard sensor payloads (e.g., which may include Radar; LIDAR; cameras; etc.) and/or between the driver system(s) and the (centralized) vehicle computer. In this example, high data rate connections to various vehicle endpoints can be integrated into the physical structure of the vehicle platform (e.g., passing through the vehicle body; an example is shown in FIG. 11; a second example is shown in FIG. 12) and may be available to the driver system(s) as a vehicle resource (e.g., provided via a vehicle resource connection 124).

### 1.2 Variants.

In a first set of variants, a vehicle system can include a Drive-by-Wire (DBW) vehicle platform, the DBW vehicle platform including: a computing system; a plurality of vehicle systems; and a low-level communication network connecting the computing system to the plurality of vehicle systems; and a vehicle interface including: a set of resource connections for a driver system, the set of resource connections including an Input Output (I/O) port, the I/O port connected to the computing system and configured to communicatively couple the API with a driver system; and an Application Program Interface (API) which is configured to: receive a set of driver inputs from the driver system; transform the set of driver input into a set of vehicle commands; and provide the set of vehicle commands to the computing system, wherein the computing system is configured to automatically control the plurality of vehicle systems, via the low-level communication network, based on a set of vehicle commands.

In a second set of variants, nonexclusive with the first set, a method for a Drive-by-Wire (DBW) vehicle (e.g., which includes a computing system; a plurality of vehicle systems; and a communication network connecting the computing system to the plurality of vehicle systems) can include: providing a set of vehicle resources within an enclosure of the DBW vehicle configured to house a modular autonomous agent, the set of resources including: a power connection coupled to a power source of the DBW vehicle platform; a cooling connection coupled to an onboard thermal management system of the DBW vehicle platform; a data connection communicatively coupled with an Application Program Interface (API) of the computing system; and a set of mounts coupled to the enclosure; at the API, receiving a set of inputs from the modular autonomous agent via the data connection, the inputs received with a first communication protocol; with the API, transforming the set of driver input into a set of vehicle commands and providing the set of vehicle commands to the computing system; based on a first model associated with the communication network, distributing vehicle control instructions, based on the vehicle commands, to the plurality of vehicle systems via the communication network; and determining feedback for the modular autonomous agent and providing the feedback to the modular autonomous agent via the API, the feedback including: a vehicle state including values for a set of vehicle state parameters; and a set of dynamic operational restrictions associated with the vehicle state.

### 2 Benefits

Variations of the technology can afford several benefits and/or advantages.

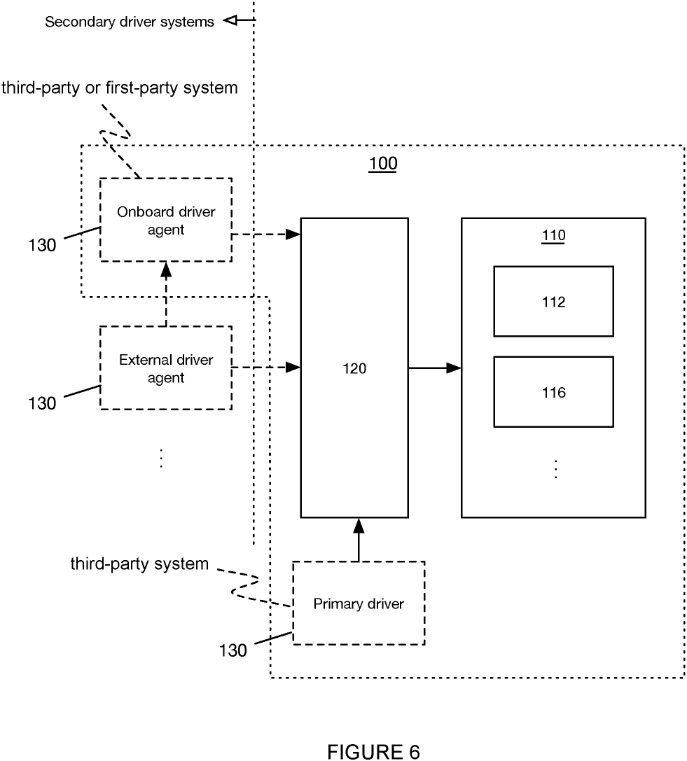

First, variations of this technology can facilitate integration of autonomous driving agents within a vehicle platform. Such variants can reduce the communication burden on the autonomous driving agent using a vehicle interface. The vehicle interface can provide a software abstraction which transforms high-level, driver inputs into system level commands/controls for individual vehicle components, thus allowing an autonomous agent to drive the vehicle without handling low-level messaging (e.g., which may be vehicle specific or configuration specific). As an example, instead of interfacing with dozens of electronic control units (ECUs), a driver system can interface with a single software abstraction/interface (e.g., software interface 122, such as an API). Second, variations of this technology can facilitate modular integration of various autonomous driving agents and/or autonomous sensor payloads within a single vehicle platform (and/or within any type of vehicle platform which can be operated by and/or integrated with the vehicle interface). Third, variations of this technology can allow autonomous computing and/or vehicle control to be centralized to reduce the wiring complexity and/or wiring length in an autonomous vehicle platform (e.g., for individual connections and/or net wiring length; which can drive cost/weight savings; which can improve latency characteristics, signal integrity, and/or signal to noise ratio). Fourth, variations of this technology can improve the robustness of communication channels and/or computing systems in an autonomous vehicle platform with improved redundancy, physical protections (e.g., vibration mitigation, fireproofing, ingress protections, etc.), security protections (e.g., data encryption, physical security, etc.), auditability, and/or otherwise suitably improve communication robustness. Fifth, variations of this technology can improve the auditability of (multi-party) autonomous vehicle operations by logging driver inputs, vehicle commands, vehicle data, high-level driver feedback, and/or other information which can be meaningfully surfaced to and/or interpreted by a human (e.g., such as a law enforcement officer, autonomy engineer, automotive engineer, etc.). Additionally or alternatively, the logger can provide highly robust (e.g., physically redundant, communicatively redundant, etc.), high-survivability storage of vehicle communications which may be recoverable in the event of an accident, hazard scenario, and/or loss of primary vehicle function, which may be used for root cause analysis and/or insurance purposes. Sixth, variations of this technology can provide a standardized, extensible programmatic vehicle interface that enables third-party interaction (e.g., control, feedback, etc.; by primary and/or secondary driver systems) of the vehicle platform (e.g., example in FIG. 6). Seventh, variations of this technology can decouple the digital security of an autonomous computing system (e.g., an AI driver) from the vehicle platform being controlled by the autonomous computing system, which may reduce or eliminate common-mode security vulnerabilities. For example, a security vulnerability which compromises the security integrity of a driver system may not translate to a vehicle vulnerability (and thus may be mitigated without impact to control in some circumstances, etc.). Eighth, variations of this technology can facilitate redundant communication between an autonomous driver system(s) and vehicle controls (e.g., via multiple native CAN/LIN buses, etc.; without the driver managing multiple communication networks). Ninth, variations of this technology can natively integrate and/or manage vehicle resources (e.g., high data-rate connections, cooling, off-board communications, cleaning fluid, GPS antenna, etc.) which may be utilized by one or more driver systems (e.g., which may avoid additional installations of such resources to facilitate driver operation). Tenth, variations of this technology can facilitate modularization and/or democratization of AV stack elements, where various driver systems may focus on different aspects of vehicle operations (e.g., planning, collision avoidance, environmental perception, etc.), while utilizing the same set of vehicle resources and each communicating with the vehicle platform via the vehicle interface.

However, variations of the technology can additionally or alternately provide any other suitable benefits and/or advantages.

### 3 System

The system 100, an example of which is shown in FIG. 1A, can include: a vehicle platform 110; a vehicle interface 120; and/or any other suitable components. The system 100 can optionally include driver system 130, an auxiliary sensor payload 140, a logger 150, and/or any other suitable components. However, the system 100 can additionally or alternatively include any other suitable set of components. The system functions to facilitate control of the vehicle platform based on driver inputs 202 received at the vehicle interface. Additionally or alternatively, the system can function to facilitate installation and/or operation of a driver system (e.g., such as an AI driver or autonomous agent; modular driver system) and/or an auxiliary sensor payload onboard the vehicle platform. However, the system 100 can have any other suitable functionality.

### 3.1 Vehicle Platform

The vehicle platform 110 preferably functions to facilitate traversal based on the driver inputs 202. Additionally or alternatively, the vehicle platform can function to house and/or structurally support physical hardware (e.g., hardware interface 126) of the vehicle interface 120, driver system 130, and/or auxiliary sensor payload 140. Additionally or alternatively, the vehicle platform can function to supply vehicle resources such as power, cleaning fluid (e.g., water, air, cleaning agents, etc.), cooling fluids (e.g., pre-cooled working fluid, air, etc.) and/or features (e.g., extended surfaces; passive heat sink; etc.), which can be utilized by various system elements (e.g., driver system, sensor payload, vehicle systems, etc.). Additionally or alternatively, the vehicle platform can facilitate execution of method S100 and/or elements thereof.

The vehicle platform 110 is preferably a drive-by-wire (DBW) vehicle, but can additionally or alternatively be a fly-by-wire aircraft or any other suitable land vehicle (e.g., roadway vehicle, rail vehicle, off-road vehicle, etc.), watercraft, aircraft, spacecraft, or other vehicle. The vehicle platform can be an automobile, semi-truck (e.g., Class 8 vehicle), autonomous vehicle (e.g., fully autonomous, autonomous in one or more operating modes, etc.), manned vehicle (e.g., passenger vehicle, housing a driver/pilot), unmanned vehicle (e.g., including or excluding an interior cabin, driver’s seat, or manual controls; without seats, passenger doors, airbags, etc.), remotely operated vehicle (e.g., tele-operated vehicle; controlled by a remote tele-operator and tele-operation system; etc.), cargo vehicle, and/or any other suitable vehicle. The vehicle platform can include an electric powertrain, combustion engine, and/or any other suitable propulsion systems; likewise, the vehicle platform can be an electric vehicle (EV), internal combustion engine (ICE) vehicle, a hybrid vehicle, and/or any other suitable type of vehicle platform. However, the system 100 can facilitate implementation of a vehicle interface independently of vehicle propulsion and/or energy sources/storage technologies deployed on a vehicle platform. In a first specific example, the vehicle platform can be a drive-by-wire (DBW) vehicle, which can include: throttle-by-wire, brake-by-wire, shift-by-wire, steer-by-wire, park-by-wire, and/or any other suitable x-by-wire (XBW) technology or subsystems. In a second specific example, the vehicle platform can be configured as an unmanned EV semi-truck (and/or a multi-use EV semi-truck, which can be configured with or without manual driver systems). However, the vehicle platform can be otherwise implemented. For example, variants can additionally or alternatively include XBW systems which can operate in conjunction with redundant (mechanical) fallback systems for manual operator controls (e.g., within a manually operated driver system; such as a steering rack or brake line), or may altogether exclude mechanical connections to various actuation systems.

The vehicle platform can include a set of vehicle control systems 112, a set of vehicle systems 114, a set of vehicle sensors 116, and/or any other suitable set of components.

The set of vehicle control systems 112 (a.k.a., vehicle controls) functions to control and/or monitor vehicle systems according to vehicle commands 210 received from the vehicle interface (e.g., based on the driver inputs 202). Additionally or alternatively, the set of vehicle control systems can function to manage vehicle resources (e.g., which may be provided to a driver system and/or enable operation of a driver system, via resource connections 124). The set of vehicle control systems can include: a powertrain control module, a brake control module, an anti-lock braking system (ABS), aerodynamic control modules (e.g., active aero control), a central control module, a central timing module, electronic stability control module, dynamic control module, a traction control module, a general electronic module, a body control module, a suspension control module, a speed control unit, a telematic control unit, a transmission control unit, a battery management system, an engine control module, a steering control unit, and/or any other suitable control modules/systems.

The vehicle control systems 112 preferably determine control instructions for the vehicle systems, which can be distributed (e.g., via the vehicle communication network 118) in the form of vehicle control signals 212. Additionally or alternatively, the vehicle control systems can facilitate execution of Block S130 and/or Block 140 of the method S100.

However, the vehicle platform can include any other suitable vehicle controls and/or vehicle control systems; and/or the vehicle platform can otherwise control vehicle systems.

The set of vehicle systems 114 functions to affect vehicle transformations according to the control instructions (and/or vehicle control signals 212) from the set of vehicle control systems. Vehicle systems can include: powertrain actuators, steering actuators, suspension actuators, brake actuators, resource management systems (e.g., thermals/cooling, power, etc.), thermal management systems (e.g., cooling systems), power management systems (e.g., BMS and/or low-voltage power management; charging systems), cleaning systems (e.g., wipers, fluid pumps, etc.), active aero systems, aerodynamic control effectors, propulsion systems, low-voltage vehicle systems, high-voltage vehicle systems, and/or any other suitable vehicle systems. However, the vehicle platform can include any other suitable vehicle systems and/or vehicle components.

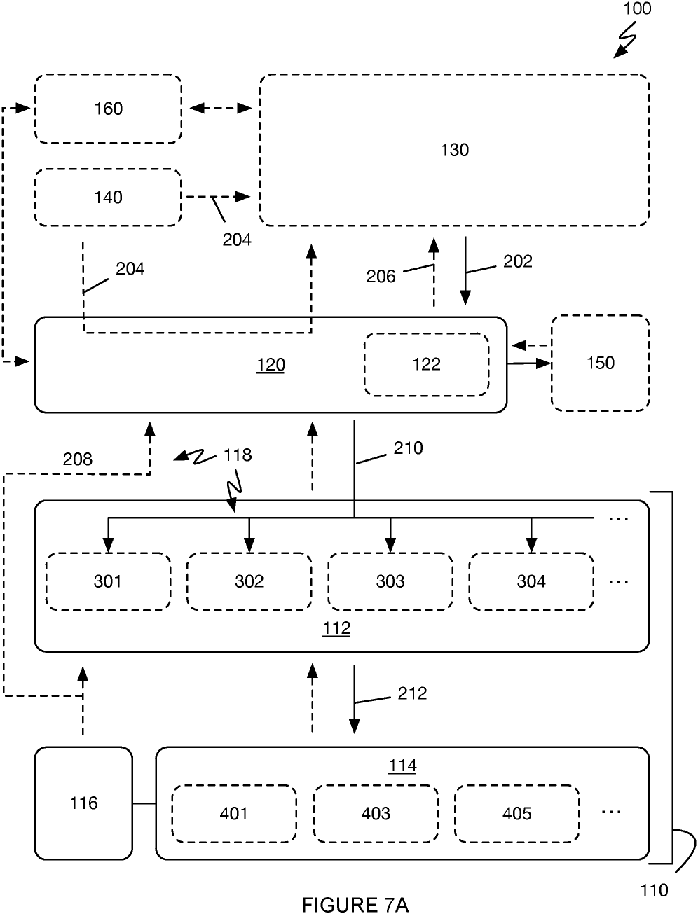

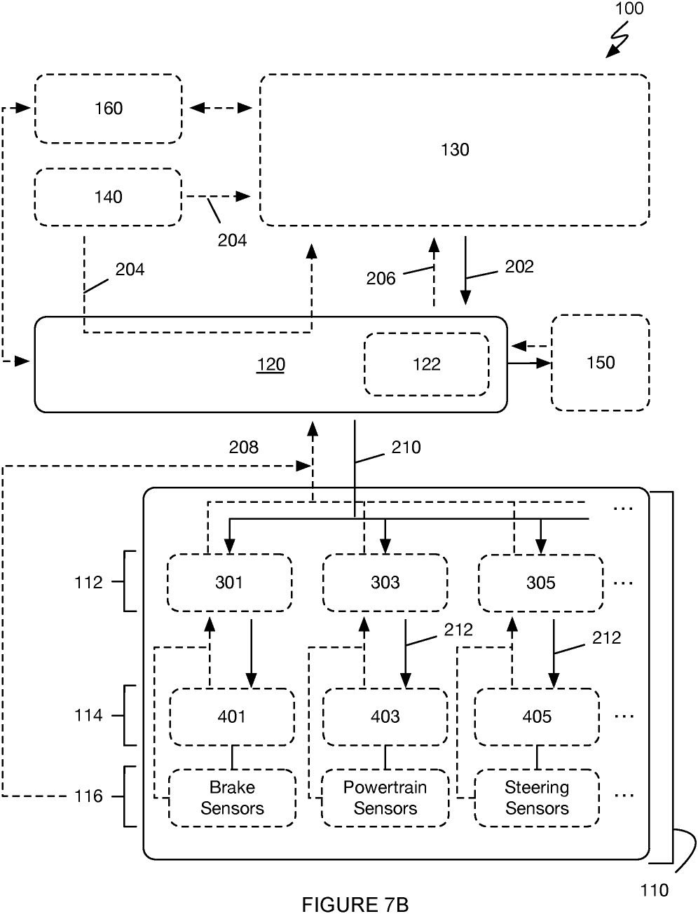

In variants (e.g., an example is shown in FIG. 7A; a second example is shown in FIG. 7B), the set of vehicle control systems 112 can include: an Anti-lock Brake System (ABS) 301, a Traction Control Module 302; a Powertrain Control Module 303, a Suspension Control Module 304, a Steering Control Module 305, and/or any other control systems (e.g., control modules/ECUs). The ABS 301 can control a set of brake actuators 401 (e.g., to facilitate brake actuation/control, such as in accordance with Block S140). The Powertrain Control Module 303 (and/or Traction Control Module 302) can control the powertrain 403 (e.g., motor controller and a traction motor, etc.; to facilitate powertrain actuation/control, such as in accordance with Block S140). The Steering Control Module 305 can control the steering actuators 405 (e.g., to facilitate steering actuation/control, such as in accordance with Block S140).

However, the vehicle platform can include any other suitable set of vehicle systems; and/or the vehicle platform can otherwise implement vehicle control according to the control instructions.

The set of vehicle sensors 116 functions to monitor the state of the vehicle platform and/or vehicle systems therein. More preferably, the set of vehicle sensors can function to collect vehicle state data 208 and/or measure vehicle state parameters, which can be used to determine a vehicle state, which can be used to facilitate control of the vehicle platform in accordance with Block S140 and/or provisions of driver feedback 206 in accordance with Block S150. For example, the set of vehicle sensors can be used to collect vehicle diagnostic data and/or other feedback which may be provided to the vehicle control systems and/or driver system (e.g., via a vehicle interface). Additionally or alternatively, vehicle sensor data can be collected and stored onboard the vehicle platform (e.g., at a logger 150 and/or a memory 152 thereof; at a memory of an autonomous agent) and/or wirelessly transmitted off-board the vehicle (e.g., via a communication module 160; for remote monitoring, storage, analysis, etc.). Vehicle sensors 116 can include: integrated vehicle sensors (e.g., integrated within various vehicle systems or subsystems; integrated vehicle state parameter sensing; etc.), throttle sensors, steering sensors (e.g., steering actuation feedback; torque sensor, steering angle sensor, power steering sensors, etc.), brake sensors (e.g., brake feedback sensing, ABS sensors, etc.), suspension sensors (e.g., pneumatic pressure sensing and switch position, such as for an air spring suspension; active suspension feedback; etc.), vehicle telemetry sensors (e.g., clock, inertial sensors, spatial sensors, etc.), spatial sensors (e.g., GPS/GNSS antenna), inertial sensors (e.g., INS, IMU, magnetometers, gyroscopes, etc.), wheel sensors (e.g., wheel speed, Hall effect sensor, etc.), tire sensors (e.g., tire pressure, tire inflation system sensors), airflow sensors, trailer sensors (e.g., axle load sensors, 5th wheel coupling sensors, etc.), environmental sensors (e.g., ambient temperature sensors), integrated ADAS sensors, BMS sensors (e.g., cell temperature sensors, voltage sensors, etc.), thermal management sensors (e.g., pressure sensors, coolant temperature sensors, compressor sensors, flow rate sensors, etc.) engine sensors (e.g. mass air flow sensor, oxygen sensor, coolant temperature sensor, manifold absolute pressure sensor, etc.), fuel system sensors (e.g. fuel level sensor, fuel pressure sensor, etc.), exhaust system sensors (e.g. exhaust gas temperature sensor, etc.), transmission sensors (e.g. transmission speed sensor, gear position sensor), lighting sensors (e.g. ambient light sensors, headlight sensors), driver system monitoring sensors, diagnostic sensors (e.g., vehicle health sensors, brake pad wear sensor / brake wear indicator, etc.), airbag sensors, and/or any other suitable set of sensors. However, the vehicle platform can include any other suitable set of vehicle sensors.

The vehicle platform 110 can include a computing system 102 which functions to perform processing within the vehicle platform. Additionally or alternatively, the computing system 102 can function to facilitate execution of the method S100 (and/or Block S120, S130, S140, thereof). Processing elements and/or processes executed by the computing system 102 can be centralized (e.g., performed at a central computer 10) and/or distributed (e.g., in a zonal architecture, in a domain architecture, etc.). Accordingly, the vehicle control systems 112 and/or computing resources associated therewith can be distributed throughout the vehicle platform (e.g., in the form of ECUs 20) and/or centralized (e.g., at a central computer 10; with single compute node performing multiple vehicle control functions; etc.). In a first example, vehicle controls can be distributed across an array of electronic control units (ECUs) 20, which control one or more vehicle systems. In a second example, vehicle controls can be distributed in a domain architecture (e.g., where vehicle systems/controls are grouped by function). In a third example, vehicle controls can be distributed in a zonal architecture, with controls processing for various systems grouped by location and/or physical arrangement (e.g., rather than by function, as in a domain architecture). In a fourth example, vehicle controls can be (at least partially) centralized, with controls processing operations occurring within a central computer 10, such as may be housed within an electronics bay of the vehicle (e.g., adjacent to processing for the software interface 122; executing API processing and/or connected via an API; singular computer performing interface and control, single board with multiple CPUs with shared memory space, etc.).

The computing system 102 can be connected to a driver system 130 via the vehicle interface 120 and/or the software interface 122 thereof (e.g., an Application Program Interface [API] and/or API gateway). As an example, the computing system can be configured to dynamically determine a vehicle state based on control of the plurality of vehicle systems and integrated sensing within the vehicle platform, wherein the computing system is configured to provide feedback to the driver system based on the vehicle state via an API of the vehicle interface. More preferably, a central computer 10 of the computing system 102 can connect to the driver system 130 (e.g., operating as a central hub/gateway). As an example, the processing for the software interface 122 and/or API can be executed by a central computer 10 of the computing system 102. However, the software interface and/or API can alternatively establish a gateway connection to the computing system 102 (e.g., with processing performed adjacent to the computing system by a dedicated module), and/or processing can be otherwise performed.

Components of the vehicle platform 110 and/or computing system 102 thereof are preferably interconnected (e.g., wiredly, wirelessly, etc.) by a vehicle communication network 118. The vehicle communication network 118 can interconnect: the central computer, ECU(s) (e.g., zonal, domain ECUs, etc.), vehicle systems, vehicle sensors, and/or any other suitable components of the vehicle platform.

The vehicle communication network is preferably coupled to the vehicle interface (e.g., indirectly, such as by a central computer 10) and used to control the vehicle systems. Additionally, the vehicle communication network 118 can transmit data between various components of the vehicle platform, which can include: vehicle state data, sensor feedback (e.g., from vehicle sensors 116), actuator feedback, vehicle commands, control instructions/signals, and/or any other suitable data. In a first example, the computing system 102 can include at least a portion of the communication network (e.g., where the communication network may interconnect ECUs and the central computer). In a second example, the communication network can be connected to the computing system (e.g., in a centralized architecture, etc.). Individual elements of the computing system can be wiredly interconnected by the communication network via cables, buses, wire harnesses, and/or any other suitable (wired) physical connections throughout the vehicle platform.

The vehicle communication network can utilize any suitable communication protocol(s), such as CAN, LIN, ECN, encrypted communication protocols, unencrypted communication protocols, and/or any other suitable protocols. Communications between elements of the vehicle platform are preferably redundant (e.g., dual redundancy, triple redundancy, etc.; utilizing redundant buses, etc.), but can be otherwise implemented. Vehicle communications can be unencrypted (e.g., unencrypted CAN; where the driver system is not connected to the vehicle communication network), encrypted, separate from the driver system communications (e.g., separated protected by an API which may include various security features, such as API key/token requirements for authentication of driver systems, etc.). Additionally, the vehicle communication network can facilitate lockstep redundancy and/or voting between redundant components and/or computing systems (e.g., for redundant central compute; redundant ECUs, etc.; to facilitate fault tolerance at parallelized and duplicative compute node[s]). However, the vehicle communication network can otherwise facilitate any suitable level of redundancy (e.g., dual redundancy, triple redundancy, etc.) for any suitable set(s) of vehicle components and/or communicative connections. As an example, lockstep redundancy can be implemented for across any suitable portion(s) of the communication network and/or for any suitable components of the computing system (and/or redundant central computer[s] thereof).

Communications between components of the vehicle platform and/or via data channels/buses of the communication network can include bidirectional communication and/or uni-directional communications which can be synchronous, asynchronous, periodic, aperiodic, serial, parallel, and/or occur with any other suitable frequency or relationship. In variants, the communication network can include single circuit data connections (e.g., CAN networks with CAN-High and CAN-Low, which may inhibit multiple/synchronous communications) and/or multi-signals data connections (e.g., allowing multiple signals to be sent at once with an ability to process those in parallel; the vehicle interface system can determine how to send signals based on base network prioritization before sending commands downstream).

The vehicle communication network is preferably a low-level communication network and includes one or more low-level sub-networks/elements which facilitate low-level messaging/communications throughout the vehicle platform (i.e., which may not be surfaced to the driver system). For example, various low-level sensory signals may be fused into a unified vehicle state parameter (value) as a part of a higher-level vehicle state (e.g., which may be provided as driver feedback via the vehicle interface). Additionally, low-level control instructions/signals, actuation feedback, and/or other low-level data can be transmitted via the low-level communication network and may not be directly surfaced to the driver system (e.g., where the driver system is not connected to the CAN/LIN bus, where the driver system is not granted authority to manage/control low-level communications, etc.).

In some variants, low-level messaging signals via the communication network can be decoupled from the driver system(s), and/or governed by separate communication protocols than the signal(s) associated with the driver inputs/feedback (e.g., communications across the data I/O connection between the driver system and the vehicle interface). For example, API inputs (e.g., driver inputs from an autonomous agent; in an XML, JSON, or other data format; higher-level communications) can be received at an API (e.g., SOAP API, REST API, etc.) of the vehicle interface with a first communication protocol (e.g., higher-level communication protocol; Ethernet, FlexRay, TTP, Ethernet TCP, etc.), wherein the communication network is decoupled from the modular autonomous agent, wherein the communication network uses a second communication protocol (e.g., CAN, LIN, SAE J1939, SAE J1850, etc.). The second protocol is preferably different from the first communication protocol (e.g., relying on a different communication standard and/or type of communication; isolated protocol, operating on a physically and/or electrically segregated communication channel; etc.). However, the first and second protocols can alternatively be similar (e.g., relying on one or more common standards, such as CAN; identical), and/or the API can be otherwise configured.

However, the components of the vehicle platform can be otherwise suitably interconnected and/or the vehicle platform can include any other suitable vehicle communication network.

In variants, the computing system and/or communication network can be configured to distribute messaging throughout the vehicle in accordance with a set of models (e.g., within the computing system, such as a central computer). The set of models can include one or more: communication model (e.g., a CAN communication model, etc.), prioritization model (e.g., deterministically prioritizing driver inputs from a plurality of drivers, such as according to a set of driver authority rules/heuristics, with decision tree[s], etc.), a restriction model (e.g., restricting vehicle commands as an element of ADAS and/or in accordance with Block S125, etc.), and/or any other suitable set of models. As an example, a communication model can be configured to facilitate handshakes between elements of the computing systems (e.g., ECUs, central compute, etc.). As a second example, a prioritization model can be configured to selectively implement driver inputs from a plurality of drivers systems (e.g., where a human driver, tele-operation system, and/or an autonomous fallback system may be higher priority than an autonomous agent). The models are preferably predetermined and/or deterministic (e.g., rules, decision trees, etc.), but can be otherwise configured. However, the computing system can otherwise direct messaging through the communication network (e.g., according to any other suitable programmatic techniques or architecture), and/or the communication network can be otherwise configured.

The vehicle platform can include a set of vehicle resources, which function to facilitate operation of the vehicle platform and/or driver system (e.g., via resource connections 124). Vehicle resources can include: vehicle power resources (e.g., 12 VDC battery, conditioned low voltage vehicle power, power management systems, etc.); thermal management resources (e.g., a refrigeration system and/or vehicle cooling system, chilled working fluid, etc.; cooling resources), data resources (e.g., integrated data cables/connections between vehicle endpoints; etc.), (off-board) communication resources (e.g., communication module 160; GPS antenna, cellular antenna, LTE antenna, etc.), cleaning resources (e.g., a cleaning fluid, such as a pressurized cleaning agent/fluid; wiper fluid; etc.), structural mounting resources (e.g., hardpoints for mounting sensor pods and/or driver system[s], etc.), and/or any other suitable vehicle resources. However, the vehicle platform can include any other suitable set of vehicle resources.

In variants, the computing system of the vehicle platform can be configured to (independently) manage vehicle resources (e.g., in absence of specific driver inputs pertaining thereto) which may be utilized by a driver system(s) to facilitate operation of the driver system. For example, the vehicle platform can include a thermal management system (i.e., a cooling system) which is configured to maintain a working fluid within a target temperature range (e.g., less than 150° C., less than 100° C., less than 60° C., less than 40° C., etc.; sub-ambient working fluid temperature range, etc.) and/or automatically circulate the working fluid through a fluid manifold of the vehicle (e.g., wherein one or more driver systems can be connected to the working fluid manifold via the vehicle interface). As a second example, the vehicle platform can be configured to independently condition low-voltage (e.g., 12 VDC) vehicle power, wherein one or more driver systems can be connected to the vehicle power resource via the vehicle interface (e.g., receiving a substantially uniform input voltage via a power connection. As a third example, the vehicle platform can maintain LTE data connectivity which may be available to the driver system(s) (e.g., facilitating connectivity via the vehicle interface). As a fourth example, the vehicle platform can be configured to automatically maintain a pressurized supply of spray fluid to facilitate cleaning of sensors (e.g., in response to a driver input; automatically and/or independently of any driver input[s]). In such variants, one or more ECU(s) of the vehicle platform can be configured to manage vehicle resources (e.g., without direct commands or driver inputs, independently of driver inputs, etc.), such as an ECU(s) for: thermal management, power management, dispersal of a cleaning agent, off-board communications, and/or any other ECU(s) dedicated to vehicle resource management.

In variants, vehicle resources (e.g., high bandwidth data connection) can be arbitrated and/or managed based on a vehicle configuration (e.g., targeted towards a configuration of a driver system and/or needs/requirements of a driver system). For example, managing vehicle resources can include: arbitrating data flow (e.g., to manage latency), bitrates, information format (e.g., downsampling sensing inputs without changing the physical components, etc.), and/or otherwise arbitrating/managing (data) resources.

However, the vehicle platform can provide any other suitable set(s) of vehicle resources which may be available to and/or utilized by driver system(s) and/or auxiliary sensor payload(s). Additionally or alternatively, driver systems can be equipped with other systems/resources, separate from those managed by the vehicle, and/or can be configured to manage any suitable set of resources utilized during operation (e.g., for example, a driver system may be equipped with a dedicated cooling system controlled by a computer of the driver system and powered with vehicle power).

In variants, the vehicle platform can be updated (and/or modules/ECUs thereof can be replaced, swapped, or modified) entirely independently of the driver system(s) and/or without impact to the driver systems. As an example, where the driver inputs (and/or other communications via the API, such as driver feedback) can be substantially independent of an architecture of the low-level communication network. In such cases, updates to the vehicle platform may not substantially impact driver systems and/or may not require corresponding updates to driver systems. As an example, a model of the vehicle communication network can be updated without modification to the communication protocol utilized by the driver system and without modification to a driver-side portion of the API.

In a first set of variants, the vehicle platform can be updated by an Over-the-Air (OTA), wirelessly updating software (e.g., a software module/model, etc.), firmware, and/or a configuration of the computing system (e.g., a central computer thereof) of the vehicle platform. For example, the vehicle platform can be updated with an OTA update received via a communication module 160. In a second set of variants, the hardware of the vehicle platform and/or computing system thereof can be updated independently of the driver system. However, the vehicle platform can alternatively be updated concurrently/simultaneously with a driver system, remain in a unitary configuration (e.g., without being updated; based on a certification or regulatory standard; where the driver system[s] may or may not be updated; etc.) and/or can be updated with any other suitable relationship to the driver system(s). Alternatively, the vehicle platform may not be updated and/or can be otherwise implemented.

In a second set of variants, the vehicle platform can facilitate updates to a driver system(s) (e.g., OTA updates received via a communication module; facilitate driver system updates via the resources and/or resource connections provided on the vehicle platform). For example, the driver system(s) can be updated by an Over-the-Air (OTA), wirelessly updating software (e.g., a software module/model, etc.), firmware, and/or a configuration of a driver computing system 132. For example, the driver system can be updated (independently of the vehicle platform) with an OTA update received via a communication module 160. In a second set of variants, the hardware of the driver system can be updated (and/or modularly interchanged) independently of the vehicle platform.

However, the system can include or be used with any other suitable vehicle and/or vehicle platform.

### 3.2 Driver System

The system can optionally include or be used with a driver system 130, which functions to generate a set of driver inputs 202 and/or determine driving decisions which are used to command the vehicle platform. The driver system (which, in some variants, may be interchangeably referenced herein with “AI driver” and/or “autonomous agent”) preferably generates driver inputs using sensor data from the vehicle sensors, the auxiliary sensor payload, and/or any other suitable data sources (e.g., local memory storage, remote databases, remote data sources, etc.). The driver system can additionally generate inputs based on driver feedback from the vehicle platform. In variants, the vehicle platform and/or vehicle interface can be driver system agnostic, insofar as the vehicle interface and the vehicle platform can operate independently of the hardware architecture and software modules of the driver system. As an example, a driver system may be included as an aftermarket add-on installation, wherein the system includes resources (e.g., and resource connections) to support the driver system installation.

In variants, the driver system can include a (driver) computing system 132 which functions to determine driver inputs based on the driver feedback and the auxiliary sensor data. In a first set of variants, the driver computing system 132 can determine driver inputs with a set of models, which can include one or more: machine learning (ML) model, neural network (e.g., deep neural networks; CNN, RNN, FCN, ANN), a cascade of neural networks, Bayesian networks, Markov chains, predetermined rules, probability distributions, heuristics, probabilistic graphical models, classifiers (e.g., binary classifiers, multiclass classifiers), or other models. As an example the driver system can be an autonomous agent configured to autonomously determine driver inputs based on the driver feedback and the auxiliary sensor data. In a second set of variants, nonexclusive with the first, the driver system can include a deterministic (fallback) controller which functions to autonomously determine the driver inputs (e.g., with classical programmatic techniques; according to a predetermined decision tree; etc.). In a third set of variants, the driver computing system 132 can be configured to determine the set of driver inputs based on communications received from a remote tele-operation system (e.g., via WebRTC, via an encrypted tele-communication channel, etc.; via an antenna, such as an antenna of the auxiliary sensor payload or a communication module integrated into the vehicle platform, etc.). In a fourth set of variants, the driver computing system can be configured to determine the set of driver inputs based on a set of manual inputs received from a human (e.g., a remote human operator, an onboard human operator; inputs from a steering wheel, inceptor, throttle, side-stick, push-buttons, etc.). For example, the driver system can include a human machine interface (HMI) onboard the vehicle, which can include a steering wheel and a throttle pedal (gas pedal). Alternatively, the driver system and/or the vehicle platform can altogether exclude an onboard HMI (e.g., where the vehicle platform does not include a substantially transparent front windshield/windscreen) and/or can be otherwise configured.

As an example, the driver system(s) can include: an autonomous agent, an autonomous fallback system, a tele-operation system, a manual operation system (e.g., local, remote, etc.), and/or any other suitable driver systems.

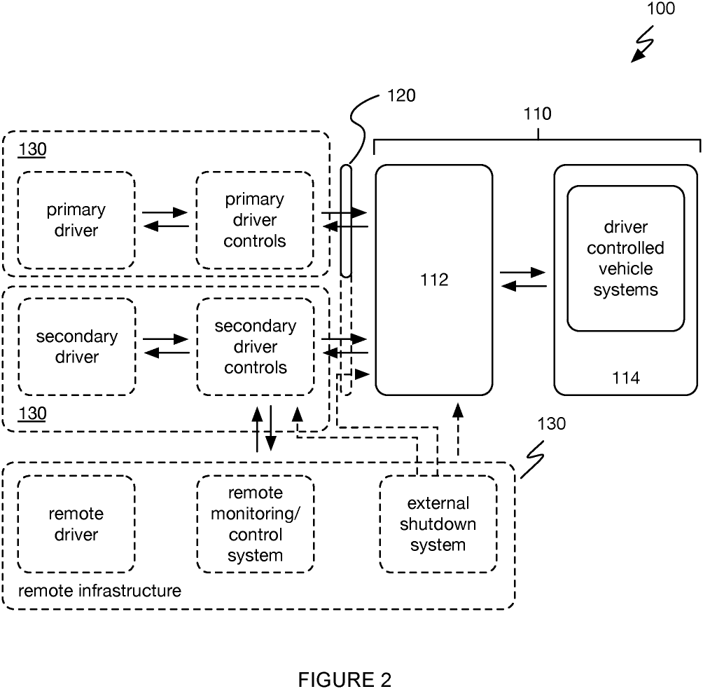

In variants, the system can include or be used with a single driver system (e.g., a primary driver system; AI driver) or multiple driver systems (e.g., an example is shown in FIG. 2; a higher-priority driver system and a lower-priority driver system; etc.). For instance, in a specific example, a secondary driver can be used to facilitate navigation of the vehicle prior to installation of a primary (autonomous) driver system, such as by a remote operator. One or more secondary driver systems can interface with the vehicle platform directly or via the vehicle interface (e.g., with one or more acting as a primary control authority and/or validating a primary control authority at any given time), and/or can be otherwise suitably implemented.

In variants which include a plurality of driver systems, driver inputs from each the respective driver systems can be prioritized and/or selectively implemented. For example, driver inputs from a highest-priority driver system (e.g., a human-operated driver system) can override at least a subset of driver inputs from lower-priority driver systems (e.g., an autonomous agent).

Additionally or alternatively, the vehicle platform 110 and/or computing system 102 thereof can be configured to arbitrate between driver inputs received from a plurality of driver systems based on a predetermined and/or deterministic priority associated with the driver system (e.g., as an element of a prioritization model). Additionally or alternatively, the vehicle platform can be configured to arbitrate between commands associated with driver inputs and ADAS systems (e.g., restricting commands from the driver with ADAS systems). For example, the computing system of the vehicle platform can be configured to: dynamically determine a set of performance limitations based on a vehicle performance envelope, and restrict vehicle commands based on the set of performance limitations and ADAS. In this example, the API can be configured to provide feedback to the driver system which can include: advisory values for each of the operational limits; control restriction alerts (e.g., when a driver input is satisfies a threshold value of a performance limitations; in response to a restriction of driver command; where one or more driver inputs is being overridden by ADAS or a higher-priority driver system; etc.).

However, the system can include or be used with any other suitable driver system(s). Alternatively, the system can include a removable driver system, a modular set of (interchangeable) driver systems, or can otherwise altogether exclude a driver system in one or more configurations.

### 3.3 Sensor Payload

The system can optionally include or be used with an auxiliary sensor payload 140, which functions to collect auxiliary sensor data 204, which can be used to facilitate environmental perception and (autonomous) vehicle navigation with a driver system(s). Additionally, the auxiliary sensor payload can function to augment integrated vehicle sensing capabilities. Additionally or alternatively, sensors of the auxiliary sensor payload can function to collect data on various intrinsic parameters (e.g., pertaining to the ego vehicle platform), extrinsic parameters (e.g., pertaining to the environment and/or vehicle surroundings), and/or any other suitable parameters. Additionally or alternatively, the sensors can function to collect inputs for a driver system (e.g., autonomous agent) to facilitate vehicle operation. The set of sensors can include: redundant sensors (e.g., redundant with integrated vehicle sensors, same sensing modalities, different sensor modalities, etc.), perception/guidance sensors (e.g., cameras, short range LIDAR, long range LIDAR, Radar, sonar, etc.), environmental sensors (e.g., cameras, time-of-flight sensors, temperature sensors, pressure sensors, wind speed/direction sensors, barometers, acoustic sensors, etc.), vehicle movement sensors (e.g., motion sensors, location sensors; inertial sensors, etc.), computer vision (CV) sensors, cameras (e.g., stereocamera, hyperspectral, multi-spectral, video camera, wide-angle, CMOS, CCD, thermal camera, etc.), time-of-flight sensors (e.g., Radar, LIDAR, sonar, etc.; short range LIDAR, long range LIDAR, etc.), inertial sensors (e.g., accelerometers, gyroscopes, magnetometers, IMU, INS, etc.), external antennae (e.g., GPS, cellular, Bluetooth, Wi-Fi, Near Field Communication, etc.), and/or any other suitable sensors.

In variants, the auxiliary sensor payload can include groups of sensors, or ‘pods’, which can be configured to attach to a set of external mounts of the vehicle interface (e.g., a mount; an example is shown in FIG. 11). Additionally or alternatively, sensor pods can be defined as a set of sensors mounted within a predetermined distance of each other (e.g., within 20 cm, 50 cm, 1 m, etc.; of each remaining sensor of the pod), supported by a set of vehicle resources (e.g., a shared cooling line, shared high-bandwidth data connection, shared power connection, etc.; dedicated resources for individual systems/sensors, etc.), and/or can be otherwise suitably defined. As an example, the auxiliary sensor payload can include a pair of sensor pods arranged on opposing sides of a midsagittal plane of the vehicle platform, each supported by a respective mount. In variants, sensor pods (and/or the mounts supporting a sensor pod) can be modularized and/or reconfigurable. As a first example, the vehicle platform may be configured to operate in conjunction with various autonomous agents (a.k.a., AV drivers) by swapping out a modular sensor pod and/or by reconfiguring a sensor pod to the particular sensor stack utilized by an autonomous agent. As a second example, in some AV scenarios it may be advantageous to include one or more additional forward-facing cameras (e.g., thermal cameras, imaging sensors, video cameras, etc.), which may be useful in a particular context of the driver system (e.g., easily auditable/interpretable by a human; based on the type of sensors and/or sensor arrangement associated with training data used for an autonomous agent of a driver computing system, etc.) or a customized application of the autonomous agent. Additionally or alternatively, a single (e.g., modular) sensor pod may support one or more driver systems (e.g., autonomous agents).

Additionally or alternatively, the auxiliary sensor payload can include sensors/elements (e.g., an array of sensors) arranged between a pair of sensor pods (and/or a pair of mounts supporting a first and a second sensor pod), at a rear end of the vehicle, at a front end of the vehicle, above a cabin/body of the vehicle, and/or any other suitable auxiliary sensor elements.

However, the system can alternatively include a removable auxiliary sensor payload or can otherwise altogether exclude an auxiliary sensor payload (e.g., in one or more configurations).

### 3.4 Vehicle Interface

The vehicle interface 120 functions to establish a communicative connection between the driver system(s) and the vehicle platform (e.g., transforming driver inputs into vehicle commands associated with vehicle control systems; providing feedback and/or sensor data from vehicle sensors and/or auxiliary sensors). Additionally or alternatively, the vehicle interface can function to facilitate physical integration of a driver system and/or auxiliary sensor payload onboard the vehicle platform.

Accordingly, the vehicle interface can include both a physical portion (a.k.a., physical interface), which functions to facilitate physical integration of a driver system with the vehicle platform, and a software interface, which functions to facilitate communicative integration of the driver system with the vehicle platform. Alternatively, the vehicle interface can only include a physical interface, only include a software interface, and/or include any other interface or combination thereof.

The physical interface 126 (a.k.a., hardware interface) can include a physical mounting structure and/or resource connections for the driver system (e.g., within an enclosure of the driver system). Additionally or alternatively, the physical interface can include the mounting structure and/or resource connections for the auxiliary sensor payloads (e.g., at a vehicle exterior/periphery). The physical interface preferably includes a unitary physical connector (e.g., for each resource connection and/or for each onboard vehicle resource provided to the driver system), but can alternatively include redundant physical connectors per vehicle resource/connection (e.g., establishing communicative and/or physical redundancy), multiple connectors (e.g., a fluid inlet port and a fluid outlet port), and/or any other suitable number of connections. As an example, any suitable set of vehicle resource connections can be integrated into a single connection and/or provided within a unitary housing/enclosure for the driver system. A dedicated physical interface is preferably provided for each separate driver system, however various vehicle resources and/or resource connections can be shared by multiple drivers, and/or driver systems can be otherwise physically integrated. The physical interface can be shared by the driver system and an auxiliary sensor payload (and/or can extend between and connect a driver system and an auxiliary sensor payload; such as a high-bandwidth data connection) or the vehicle platform can include separate sub-elements, which can provide distinct sets (e.g., disjoint sets, overlapping sets, etc.) of vehicle resources to the driver system and the auxiliary sensor payload. For example, the physical interface can include a cleaning fluid resource connection to the auxiliary sensor payload (e.g., which may not be provided to the driver system).

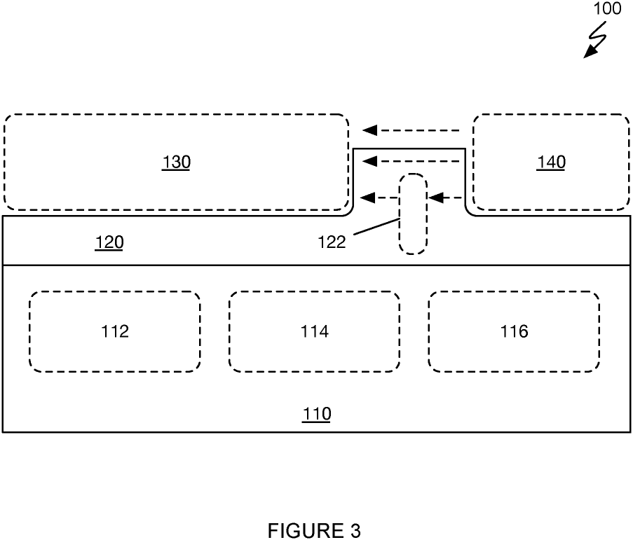

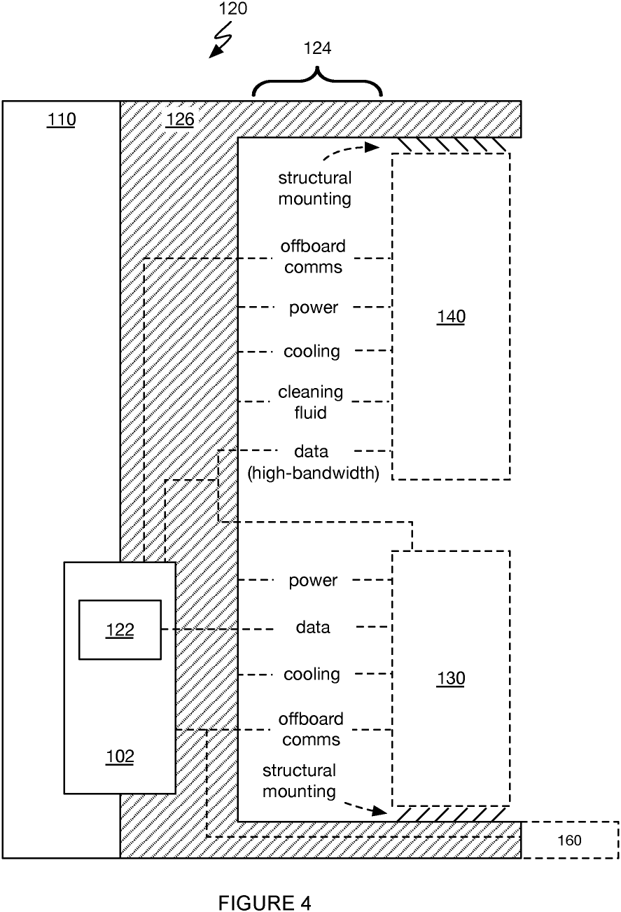

In a first example, the physical interface can include a set of mounts within an electronics bay (e.g., electronics enclosure with physical security protections, thermal mitigation, vibration mitigation, ingress protection, EMI shielding, etc.; commonly housing onboard compute and/or driver compute; etc.) of the vehicle which are configured to mount and structurally support the driver system. As a second example, the physical interface can include a set of external mounts to support a modular sensor payload at a periphery of the vehicle. Additionally, the physical interface can include a set of resource connections 124 (e.g., proximal to the mounting structures; an example is shown in FIG. 4) to supply various vehicle resources to the driver system and/or auxiliary sensor payload. For example, the physical interface can include: a power connection, cooling fluid connection (e.g., air, sub-ambient coolant, etc.), a cleaning fluid connection (e.g., sensor cleaning fluid, wiper fluid, etc.), a cellular data connection (e.g., LTE data, etc.), a high-speed data channel, and/or any other suitable resources. In a specific example, the physical interface can include a set of high-speed wired connections extending between the driver system and the auxiliary sensor payload (e.g., through an interior of the vehicle, integrated into the physical structure of the vehicle; an example is shown in FIG. 3), configured to transmit high-speed data such as environmental imaging data between the auxiliary sensor payload and the driver system.

In variants, the physical interface (e.g., an example is shown in FIG. 4) can include one or more: structural mounting connection, cooling connection, power connection, data connection, (off-board) communication connection, cleaning fluid connection, high-bandwidth data connection, and/or any other suitable resource connections. In such variants, the physical interface can include: an I/O data port, a set of fluid ports (e.g., of a fluid manifold connected to a thermal management system, such as a refrigeration system, of the vehicle platform; wherein the vehicle platform is configured to circulate a chilled working fluid through the first set of fluid ports); a set of electrical terminals (e.g., electrically connected to vehicle power source); a set of structural mounts; and/or any other suitable components. As an example, the set of structural mounts can include a first set of mounts enclosed within an interior of the vehicle platform and a second set of mounts at a vehicle exterior, wherein the set of resource connections further include a set of data channels extending between a first end, proximal to the first set of mounts (e.g., within an electronics bay and/or driver system enclosure, and a second end, proximal to the second set of mounts (e.g., at a vehicle exterior; extending through an interior of a mount of the auxiliary sensor payload; an example is shown in FIG. 12). As a second example, the physical interface can include a first manifold (e.g., circulating a first working fluid) defining a first set of fluid ports proximal to the driver system (e.g., within an enclosure of the driver system) and a second fluid manifold (e.g., providing a cleaning agent and/or pressurized working fluid) defining a second set of fluid ports proximal to the auxiliary sensor payload (e.g., extending through an interior of a mount; at a vehicle periphery and/or exterior; etc.).

The physical interface can include an electrical connection for the driver system to establish communicative connectivity to the vehicle platform (e.g., via software interface). As an example, where an onboard computing system of the vehicle interface is adjacent to the driver system (or physical mounting hardware and resource connections thereof), such as when both systems are arranged within an electrical bay, a short cable length (e.g., less than 1 meter, less than 10 cm, etc.) or a substantially rigid connector may be used. The electrical connection to the driver system can be singular/unitary, redundant, duplicative, or can be otherwise implemented. In one variant, the physical interface can include an Input Output (I/O) port which is connected to the computing system (and/or a central computer thereof) and configured to communicatively couple the software interface (e.g., API) with the driver system. As an example, the physical interface can be redundant I/O ports (and/or I/O connections) between a single driver system, such as an autonomous agent, and the vehicle platform. As a second example, a set of the resource connections of the physical interface can include redundant power and/or data connections.

In one variant, each connection of the physical interface preferably extends through and/or is provided within a unitary enclosure of the driver system (e.g., the vehicle interface can include the enclosure). For example, a driver system can be housed within a unitary enclosure (e.g., a high survivability enclosure, which can include fireproofing, vibration damping, electrical isolation, thermal insulation, thermal regulation, ingress protection, physical security protections, and/or any other suitable protections).

As an illustrative example, the physical interface can be a “plug-and-play” interface, which connects the driver system to the vehicle platform.

However, the driver system can be otherwise electrically connected and/or physically to the vehicle interface and/or vehicle platform.

In variants, the physical interface can be configured to provide vehicle resources to the driver system and/or auxiliary sensor payload (and/or establish communicative connectivity between the driver system and the auxiliary sensor payload) contemporaneously with execution of S100 and/or operation of the vehicle platform.

The processing operations of the software interface are preferably executed at an onboard computing system, which can be provided various protections to reduce risk in various hazardous scenarios. For instance, the software interface can be arranged within a vehicle electronics bay (e.g., adjacent to a driver system and/or computing resources thereof). In variants, the onboard computing system executing processing operations of the software interface can be housed within a high survivability enclosure which can include: fireproofing, vibration damping, electrical isolation, thermal insulation, thermal regulation, ingress protection (e.g., IP65; IP67; etc.), physical security protections (e.g., physical lock, tamper seals, etc.), and/or any other suitable protections. In one variant, the computing system of the vehicle interface can be housed in a common enclosure along with the driver system (e.g., and/or an autonomous processor thereof). Alternatively, the computing system can be housed and/or packaged separately from a driver system module.

The software interface can receive a set of driver inputs from the driver system in the form of parameter values for driver-controlled parameters, which can include: a throttle parameter, a brake parameter, indicator parameters, a transmission parameter, a sensor cleaning parameter, and/or any other suitable parameters. Driver input parameter values can be: binary (e.g., left turn signal ON), bounded within a range of inputs (e.g., discrete or continuous; predetermined), unbounded (e.g., where vehicle constraints may be subsequently imposed), and/or received in any suitable format. Driver inputs can be unitless or can correspond to vehicle parameter values (e.g., brake pressure, steering angle).

Driver inputs are preferably received via a direct (wired) electrical connection between the driver system and the vehicle interface (e.g., part of the physical interface), but can additionally or alternatively be received via any suitable wired and/or wireless communication channel. Communications between the vehicle interface and the driver system are preferably encrypted (e.g., received via a first form of encrypted communication), but can be otherwise suitably implemented. In variants, communications between the vehicle interface and the driver system can be encrypted via the same form of encryption as the vehicle platform communications or can rely upon a different/separate form of encryption.

Driver inputs are preferably received at the vehicle interface in the form of push-updates and/or a substantially continuous stream of driver inputs, but can be received with any other suitable frequency/timing. In response to receiving a drive input, the software interface determines vehicle commands based on the driver inputs in real-time (e.g., substantially instantaneously, within several milliseconds, at least one order of magnitude faster than the dynamic response of the vehicle associated with the command, etc.). Driver inputs can be received via a set of standardized calls (e.g., standardized interface calls defined by the system, etc.), such as programmatic interface calls, but can be received in any other format.

The software interface can determine vehicle commands based on the driver inputs: deterministically (e.g., such as according to a lookup table), dynamically (e.g., based on a vehicle state and/or contextual vehicle data, environmental context, etc.), using a set of models (e.g., such as a predefined mapping; based on a communication model, a driver prioritization model, etc.), and/or the vehicle commands can be otherwise suitably determined. As an example, the driver inputs can be received via a first communication protocol (e.g., Ethernet, etc.) and transformed into a set of commands which are provided to the vehicle platform via a second communication protocol (e.g., CAN, a vehicle communication protocol, etc.; via S120). Additionally or alternatively, driver inputs can directly pass through the software interface and be directly utilized as vehicle commands (e.g., such as where the driver inputs and driver feedback rely upon the same communication protocol as the vehicle network, etc.). Various driver inputs can be translated into individual (unitary) vehicle commands, a plurality of vehicle commands, and/or any other suitable set of vehicle commands. For example, a driver input such as a brake value (e.g., unitless, brake pressure, brake force, percentage, etc.) can be transformed into a plurality of associated commands and/or communications onboard the vehicle platform to a plurality of control systems, such as: anti-lock braking control, electric powertrain control, suspension control, active aerodynamic control, and/or any other suitable subsystems.

In some variants, driver inputs can be limited, restricted, and/or adjusted based on the vehicle state. For example: the vehicle interface and/or vehicle control systems can impose various protections (e.g., envelope protections, brake protections, stability protections, etc.) which decouple the driver inputs from the resulting vehicle behavior, such as in cases where the driver input exceeds the physical capabilities of the vehicle (e.g., maximum cornering constraint based on a current vehicle speed, maximum braking constraint based on estimated coefficient of friction, etc.). As a second example, the vehicle interface and/or vehicle platform can ignore or neglect drive inputs in response to determining satisfaction of a fault event based on the vehicle context (e.g., such as a driver input to engage a parking brake or transition into a reverse gear above a threshold speed).

In some variants, driver inputs can be directly translated into vehicle commands and/or associated control signals which are executed by the vehicle platform (vehicle systems thereof) without adjustment or modification. For example: a turn signal driver input can be directly transformed into a vehicle action/response (e.g., without intervention by the vehicle interface and/or without influence by vehicle control systems).

However, the software interface can otherwise suitably determine vehicle commands based on the driver inputs.

The software interface can provide feedback to various endpoints (e.g., driver systems) based on the operation of the vehicle platform. The software interface can provide feedback: periodically (e.g., in the form of a push update), aperiodically, in response to a (driver system side) pull request, in response to a remote pull request (e.g., remote API, etc.), synchronously with driver input communications, asynchronously with driver input communications, and/or with any other suitable timing. In a first set of variants, the software interface can provide driver feedback to the driver system, which can include:, vehicle protection feedback (e.g., activation of ABS, activation of traction control, etc.; current envelope limits; a set of performance limitations, such as may be dynamically determined based on a vehicle performance envelope), fault feedback (e.g., drive input fault notification), semantic notifications (e.g., “reverse gear unavailable at current speed”), indexed notifications (e.g., OBD II codes, etc.), estimated vehicle parameters (e.g., road friction estimate, wind speed estimate, fuel efficiency estimate, etc.), vehicle state data (e.g., tire pressure, axle load, etc.; vehicle control parameters; values for each of a set of vehicle state parameters; etc.), and/or any other suitable feedback. In a second set of variants, the software interface can provide feedback to remote systems, such as a remote monitoring system or a regulatory entity, via wireless communications.

In some variants, the software interface can expose all forms of active adjustability of the vehicle platform to the driver system via feedback. As an example, the software interface can provide substantially continuous feedback for parameters such as speed and steering angle, while providing periodic or request-driven feedback for secondary parameters such as tire pressure, axle loads, and/or road friction. Additionally or alternatively, any suitable set of vehicle state data and/or operational parameters (e.g., operational restrictions/limits) can be exposed to the driver system (e.g., continuously, periodically, in response to a pull request, etc.).

However, the software interface can provide any other suitable feedback to the driver system.

However, the system can include any other suitable vehicle interface.

### 3.5 Logger

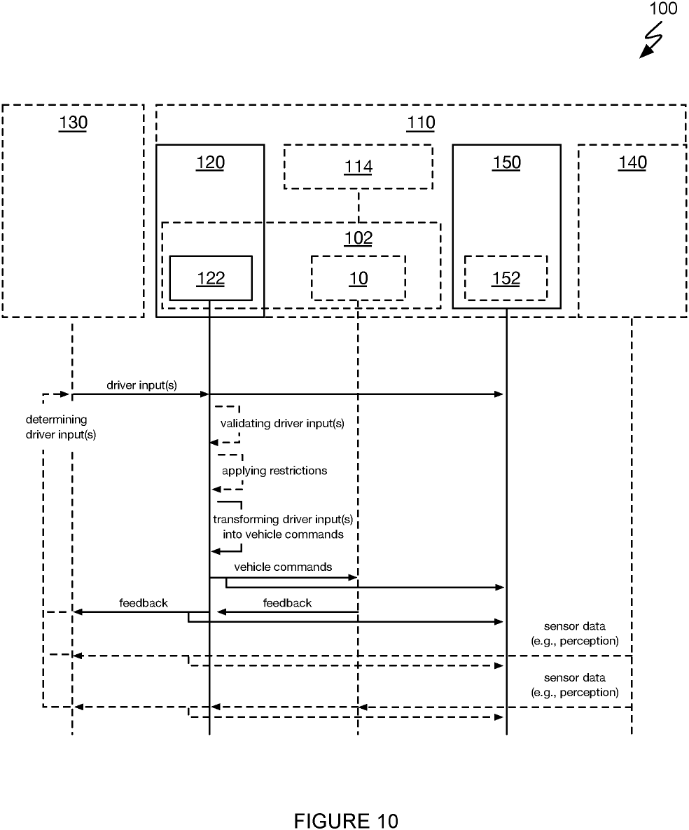

The system can optionally include or be used with a logger 150 (e.g., an example is shown in FIG. 1B), which functions to log input and output communications from the vehicle interface (e.g., along with a timestamp, index, other suitable identifiers, etc.; within a local memory 152 of the logger; an example is shown in FIG. 10). Additionally, the logger can function to log additional data or communications for components of the vehicle platform. As an example, it can be particularly advantageous for insurance, regulatory, and/or liability determinations to have a stored log of the vehicle interface communications when elements of the system are separately certified (e.g., illustrating compliance of an individual system), governed by separate regulatory guidelines, and/or provided by separate entities. The logger can be integrated into the vehicle interface and/or housed commonly with the vehicle interface (e.g., in a common enclosure), or can be separately arranged within the vehicle (e.g., rear of the vehicle; onboard the vehicle platform). In a specific example, the logger is housed within an electronics bay of the vehicle, in a separate fireproof (and/or high temperature), shock resilient, and/or accident/crush resilient enclosure from the vehicle interface compute. In variants, the logger can optionally be independently powered and/or include a backup power source to maintain persistent functionality in the event of various failure scenarios (e.g., primary vehicle power failure, etc.). The system can include a single logger or a plurality of loggers (e.g., such as logger monitoring each end of a communicative connection between the driver system and the vehicle interface; for multiplicative redundancy; offset by at least a predetermined distance within the vehicle based on accident vulnerability characteristics; offset by a predetermined distance to mitigate signal interference; etc.). Alternatively, the system can otherwise exclude a logger (e.g., where logging data may be wirelessly transmitted and stored remotely), and/or can be otherwise suitably implemented.

The logger is preferably configured to store data transmitted across the software interface (e.g., logging all API communications) at a local memory (e.g., RAM, ROM, flash, hard drive, volatile, non-volatile, etc.), but can additionally or alternatively store/log data transmitted via the communication network, communications from the computing system 102 (and/or central computer 10 thereof), driver system communications, driver inputs 202, auxiliary sensor data 204, driver feedback 206, vehicle state data 208, vehicle commands 210, vehicle control signals 212, and/or any other suitable data.

In variants, the logger can provide feedback to the vehicle interface to share data about the logger status (e.g., connected, battery state if applicable, etc.) and/or to periodically offload vehicle data (e.g., at the end of a trip, after a predetermined duration, etc.; via a communication module 160, etc.). Alternatively, the logger may only receive data from the vehicle interface unidirectionally or can be otherwise configured.

### 3.6 Shutdown System

In some variants, the system can optionally include or be used with a shutdown system, which functions to override primary and/or secondary driver inputs and command the vehicle to cease operation (e.g., come to a full stop, emergency stop, controlled/slow stop, etc.; according to a predetermined protocol, etc.). In one example, an external shutdown communication can be wirelessly received at a dedicated control module (e.g., an ECU) and used to prevent operation of the vehicle (e.g., command a full stop, engage parking brakes, etc.; prevent ongoing and/or planned operation, etc.), bypassing the vehicle interface (and/or ordinary functionality of the vehicle interface) entirely. In one example, an external shutdown communication can be received via the vehicle interface from the primary driver and/or a remotely-controlled secondary driver. However, the system can include any other suitable shutdown system, and/or can otherwise incorporate any suitable “kill-switch” type functionalities onboard and/or off-board the vehicle.

In variants, the system can incorporate redundancy at individual connections (e.g., wired/wireless communication pathways, power connections, data connections, resource connections, etc.), components, and/or processing endpoints, and/or can include system level redundancies (e.g., redundant networks, etc.) to achieve a desired level of redundancy (e.g., doubly redundant, triply redundant, triple-mode redundancy, etc.). For example, the system can include: multiplicative redundancy of components such as compute nodes, loggers, actuators, sensors, driver systems, and/or any other suitable components. Likewise, the system can include multiplicative data channels (e.g., redundant CAN/LIN networks; using the same type of communication protocol and/or different communication protocols), multiplicative resource connections (e.g., power connections to multiple/distinct power sources, redundant connections to vehicle power, etc.), and/or any other suitable redundancies. In one variant, commands can be sent to individual control systems (e.g., ECUs) via redundant communication channels (e.g., parallel CAN/LIN networks, multiple connections to a single network). In one variant, the driver system(s) can be connected to the vehicle interface by a plurality of redundant communication channels. However, the system can include any other suitable redundancies and/or redundant components/features.

However, the system can include any other suitable components.

### 4 Method

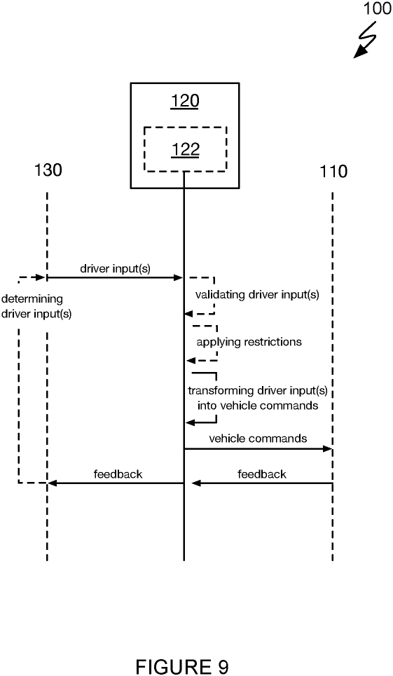

The method S100, an example of which is shown in FIG. 5, can include: determining a driver input using a vehicle interface S110; transforming the driver input into a set of vehicle commands S120; and determining control instructions based on the set of vehicle commands S130. The method S100 can optionally include: validating vehicle inputs S115; applying restrictions S125; facilitating control of a vehicle platform using the control instructions S140; and providing feedback via the vehicle interface S150. However, the method S100 can additionally or alternatively include any other suitable elements. The method S100 can function to facilitate control of a vehicle platform using a driving system (e.g., AI driver). An example of the method is shown in FIG. 9.

The method can occur once, repeatedly (e.g., during a drive cycle, in an operating mode of a vehicle, etc.), iteratively, periodically, in response to receipt of a driver input from a driver system (e.g., input request, etc.) and/or with any other suitable frequency/timing.

Determining a driver input using a vehicle interface S110 function to facilitate operation of the vehicle with one or more driver systems (e.g., an autonomous agent). The driver input is preferably received via a data connection (e.g., I/O port of the physical interface) coupled to the API.

S110 is preferably executed repeatedly (e.g., with a predetermined frequency; according to an update interval of the vehicle platform and/or the driver system) and/or substantially continuously (e.g., during vehicle traversal), but can occur with any other suitable timing. S110 is preferably executed by the vehicle platform (and/or at an API and/or central computer thereof), but can additionally include processing and/or communication with the driver system(s).

In a first variant, S110 can include receiving the driver input via the vehicle interface (e.g., via a physical resource connection; at an API of the software interface; etc.).

In a second variant, nonexclusive with the first variant, S110 can include autonomously determining driver input (e.g., at a modular driver system onboard the vehicle platform, which is decoupled from the vehicle communication network) and providing the driver input via the vehicle interface (e.g., with a first communication protocol, such as Ethernet, etc.; wherein the first communication protocol is different from the communication protocol[s] of the vehicle communication network).

The driver inputs can preferably include operational parameter values associated with driver decisions, such as a braking parameter, a steering angle, a throttle parameter. The driver inputs can include: binary parameters (e.g., left turn signal: ON), absolute parameters (e.g., a steering angle; acceleration command), relative parameters (e.g., relative to operational restrictions, such as a percentage of available torque or max braking, etc.), and/or any other suitable driver input parameters. The driver inputs are preferably determined in a uniform/standardized format and via a predetermined/singular communication protocol (e.g., at the driver portion/side of the vehicle interface), but can be otherwise determined.

However, the driver input can be otherwise determined.

In variants, S100 can optionally include validating vehicle inputs S115 which functions to validate vehicle (driver) inputs and/or the data communications between the vehicle platform and a driver system. Vehicle inputs (i.e., driver inputs) are preferably validated at the vehicle interface and/or an API thereof, but can alternatively be otherwise validated. For example, S115 can include: authenticating and API call (e.g., via a token or API key; received via an I/O channel), handshaking or voting between redundant communication channels and/or computing systems (e.g., lockstep systems, etc.; via checksum verification, hashing, etc.), validating a format of a driver input, and/or any other suitable validation/authentication elements. However, vehicle inputs can be otherwise validated; or alternatively, vehicle inputs may not be validated (e.g., where vehicle protections, higher priority driver systems, and/or ADAS may be relied upon to avoid invalid vehicle commands from being implemented, etc.).

Transforming the driver input into a set of vehicle commands S120 functions to facilitate vehicle platform operation and/or command based on the driver inputs. S120 is preferably executed by a software portion of the vehicle interface (e.g., an API) and/or within a computing system of the vehicle platform. Driver inputs are preferably automatically transformed into vehicle commands (e.g., predetermined transformation, deterministic mapping, etc.) which can be distributed throughout the vehicle platform and/or otherwise used to facilitate vehicle control via the vehicle communication network. The driver input transformation can be applied similarly (e.g., identically and deterministically) for driver inputs received from each driver system (e.g., where the API[s] performs the same transformation[s]) and/or can be different for different driver systems. As a first example, each driver system may interface with the vehicle in the same way (e.g., same format of inputs and/or feedback). Alternatively, driver systems can provide different driver inputs (e.g., with a dedicated API), which can be transformed into a unified command format (e.g., as handled by the vehicle platform).

Transforming the driver input into the set of vehicle commands can include transforming: content (e.g., transforming a relative input into an absolute command, such as percent steering into an angle at the wheels), structure (e.g., converting to a different format, converting to a different protocol, etc.), and/or otherwise transforming the driver input(s).

S120 preferably occurs in response to determination of driver inputs via S110, but can additionally or alternatively occur periodically, substantially continuously, and/or with any other suitable timing. In some variants, S120 can occur independently, concurrently, and/or contemporaneously for each of a plurality of driver systems via a respective vehicle interface. For example, a set of vehicle commands can be determined for each of a plurality of driver systems (e.g., where vehicle commands from higher-priority driver systems are configured to override commands from lower priority systems; according to a predetermined set of authority rules, decision trees, a prioritization model, etc.). Alternatively, where null inputs (or no driver inputs) are received from higher-priority driver systems (e.g., a fallback driver, a manually-operated driver system, etc.; such as in a nominal operating case where a fallback driver is inactive) via S110, the vehicle commands may be based on (fully autonomous) driver inputs from a lower-priority driver system.

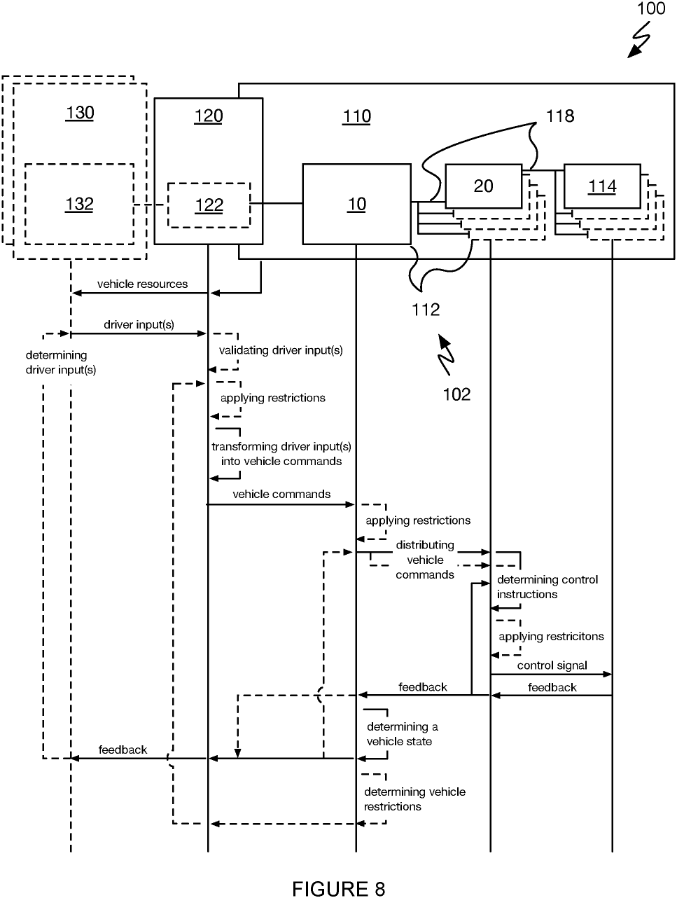

In one set of variants, an API of a central computer of the vehicle computing system can determine vehicle commands and distribute the vehicle commands (and/or a subset of parameters thereof) to the components of the computing system (e.g., ECUs) via the vehicle communication network (e.g., an example is shown in FIG. 8).

However, driver inputs can be otherwise transformed into vehicle commands.

In variants, S100 can optionally include applying restrictions S125, which functions to restrict or limit operation of the vehicle based on a set of operational limitations. In a first set of variants, operational limitations can be dynamically determined based on the vehicle state (e.g., determined based on integrated sensing and/or measurement feedback from the set of sensors onboard the vehicle platform). For example, the set of operational limitations can constrain the vehicle to operate within a performance envelope (e.g., flight envelope of an aircraft, vehicle performance envelope of an automobile, performance limits of a battery, etc.). The set of operational limitations can include or be associated with: powertrain limitations, steering limitations, power limitations (e.g., based on motor characteristics, based on battery characteristics, etc.), suspension limitations, traction limitations (e.g., based on an estimated friction and/or braking parameters), driver limitations (e.g., for a particular driver system and/or driver class; tele-operation may be limited based on predetermined and/or dynamically determined latency, etc.) and/or any other suitable set of limitations. In a second set of variants, ADAS systems (e.g., ABS, traction control, etc.) can restrict commands and/or controls.

In an illustrative example, wherein the vehicle platform includes an integrated Advanced Driver-Assistance System (ADAS), the vehicle platform can be configured to dynamically determine a set of performance limitations based on a vehicle performance envelope, wherein the computing system of the vehicle platform is configured to restrict vehicle commands based on the set of performance limitations and ADAS. Additionally, the vehicle interface (and/or API thereof) can be configured to surface limitations and/or (active) restrictions as driver feedback for the driver system (e.g., in the form of advisory values for each of the operational limits, control restriction alerts, etc.).

Restrictions and/or limitations imposed in S125 can be applied to driver inputs (e.g., at the API; limiting a range of allowable inputs), vehicle commands, control instructions, and/or can be otherwise implemented. For example, limitations imposed in S125 can be implemented at the computing system (and/or a central computer thereof) or a set of ECUs (e.g., ABS, etc.).

Determining control instructions based on the set of vehicle commands S130 functions to control the vehicle based on the vehicle commands. S130 can be executed by the computing system of the vehicle platform (e.g., ECUs), but can be otherwise suitably implemented.

Control instructions can be dynamically determined, automatically determined, determined based on the vehicle state, and/or otherwise determined. Control instructions can be determined substantially continuously, in response to receipt of a vehicle command from the vehicle interface (and/or central computer), periodically (e.g., higher frequency than associated with AV compute and/or driver input communications; same or different frequency from vehicle command updates, etc.), and/or with any other suitable frequency/timing. As an example, a control instruction can include a powertrain control module output (e.g., such as a torque command or a velocity command) which is distributed to a motor controller of an electric powertrain.

In variants, S130 can include (or occur in conjunction with) distributing vehicle control instructions to the plurality of vehicle systems via the communication network (e.g., via the network elements and/or communication protocols as described above).

However, control instructions can be otherwise suitably determined.

In variants, S100 can optionally include facilitating control of a vehicle platform using the control instructions S140, which functions to facilitate traversal and/or control the vehicle platform based on the control instructions. S140 can include: controlling actuators of the vehicle platform, which can include: powertrain actuation, steering actuation, suspension actuation, brake actuation, cleaning system activation (e.g., wipers, fluid pumps, spray valve, etc.), active aero actuation, aerodynamic control effector actuation, propulsion actuation, low-voltage vehicle actuation, high-voltage vehicle actuation, and/or any other suitable vehicle actuation. In variants, S130 and/or S140 can include determining a vehicle state, wherein the vehicle is dynamically controlled based on the vehicle state. For example, S130 and/or S140 can include feedback control schemes based on one or more vehicle state parameters. However, the vehicle actuation can include: feedforward control, feedback control, open-loop control, and/or any other suitable actuator control scheme(s).

However, the vehicle can be otherwise controlled.

In variants, S100 can optionally include providing feedback via the vehicle interface S150 which functions to facilitate driver operation of the vehicle platform. Additionally or alternatively, S150 can function to communicate: operational parameters (e.g., vehicle state parameters or a subset thereof), control restriction advisories (e.g., traction control activation; ABS activation; etc.), operational limits, and/or any other suitable driver feedback.

The driver feedback is preferably provided via the data connection (e.g., I/O port of the physical interface) coupled to the API.

Driver feedback can be provided substantially continuously and/or persistently, as a (push) notification, asynchronously with driver input communications, synchronously with driver input communications, periodically, aperiodically, in response to a trigger event (e.g., a pull request), and/or with any other suitable frequency/timing. S110 is preferably executed by the vehicle platform (and/or at an API and/or central computer thereof), but can additionally include processing and/or communication with the driver system(s). As an example, driver feedback can be aggregated from various actuator feedback and/or sensor data sources (e.g., which may be used to facilitate lower-level control) and surfaced to the driver in a higher-level and/or unified format. For example, the vehicle can include many battery temperature sensors (e.g., per cell, module, pack, etc.), and may surface an aggregate pack temperature as drive feedback via the API,

In one set of variants, S150 can include aggregating sensor data and providing driver feedback based on the aggregated sensor data (e.g., in the form of aggregate vehicle state parameter values, such as an aggregate pack temperature; unified vehicle trajectory; etc.).

In some variants, driver feedback can be selectively provided based on a driver classification (and/or driver priority). For example, the different driver feedback parameters can be selectively surfaced to different classes of drivers. In one variant, dynamic operational restrictions can be surfaced to an (autonomous) driver system (e.g., which may not be surfaced to a human operator via an HMI). Additionally or alternatively, restriction alerts (e.g., traction control activation; alert indicators, etc.) can be surface to a human driver (e.g., where normal drivers experience traction control and/or ABS activation by alert and haptic feel only).

However, feedback can be otherwise suitably provided.

However, S100 can include any other suitable elements.

In some variants, S100 can occur in conjunction with updates to the vehicle platform and/or can include updating the vehicle platform (e.g., hardware, software, models, etc.). The vehicle platform can be updated asynchronously with vehicle operation (e.g., via an OTA update) and/or execution of S100, but can alternatively be updated during vehicle operation and/or with any other suitable timing. As an example, the vehicle platform can be updated independently of (and/or without modification to) a driver-side portion of the vehicle interface and/or an API thereof.

Alternative embodiments implement the above methods and/or processing modules in non-transitory computer-readable media, storing computer-readable instructions. The instructions can be executed by computer-executable components integrated with the computer-readable medium and/or processing system. The computer-readable medium may include any suitable computer readable media such as RAMs, ROMs, flash memory, EEPROMs, optical devices (CD or DVD), hard drives, floppy drives, non-transitory computer readable media, or any suitable device. The computer-executable component can include a computing system and/or processing system (e.g., including one or more collocated or distributed, remote or local processors) connected to the non-transitory computer-readable medium, such as CPUs, GPUs, TPUS, microprocessors, or ASICs, but the instructions can alternatively or additionally be executed by any suitable dedicated hardware device.

Embodiments of the system and/or method can include every combination and permutation of the various system components and the various method processes, wherein one or more instances of the method and/or processes described herein can be performed asynchronously (e.g., sequentially), concurrently (e.g., in parallel), or in any other suitable order by and/or using one or more instances of the systems, elements, and/or entities described herein.

As a person skilled in the art will recognize from the previous detailed description and from the figures and claims, modifications and changes can be made to the preferred embodiments of the invention without departing from the scope of this invention defined in the following claims.

We claim:

1. A vehicle system comprising:
a Drive-by-Wire (DBW) vehicle platform comprising:
a computing system;
a plurality of vehicle systems; and
a low-level communication network connecting the computing system to the plurality of vehicle systems; and
a vehicle interface comprising:
a set of resource connections for a driver system, the set of resource connections comprising an Input Output (I/O) port, the I/O port connected to the computing system and configured to communicatively couple the API with a driver system; and
an Application Program Interface (API) which is configured to:
receive a set of driver inputs from the driver system;
transform the set of driver input into a set of vehicle commands; and
provide the set of vehicle commands to the computing system,
wherein the computing system is configured to automatically control the plurality of vehicle systems, via the low-level communication network, based on a set of vehicle commands.

2. The vehicle system of claim 1, wherein the computing system is configured to dynamically determine a vehicle state based on control of the plurality of vehicle systems and integrated sensing within the DBW vehicle platform, wherein the API is configured to provide feedback to the driver system based on the vehicle state.

3. The vehicle system of claim 2, wherein the feedback comprises a set of operational limitations which are dynamically determined based on the vehicle state.

4. The vehicle system of claim 1, wherein the driver system comprises a lower-priority driver system, wherein the vehicle system further comprises a second data I/O port configured to communicatively couple the vehicle interface with a higher-priority driver system, wherein, in response to receipt of priority driver inputs via the second data I/O port, the vehicle system is configured to override at least a subset of driver inputs with the priority driver inputs.

5. The vehicle system of claim 4, wherein the lower-priority driver system comprises an autonomous agent, wherein the higher-priority driver system comprises an autonomous fallback system or a teleoperation system.

6. The vehicle system of claim 4, wherein the DBW vehicle comprises integrated Advanced Driver-Assistance System (ADAS), wherein the DBW vehicle platform is configured to dynamically determine a set of performance limitations based on a vehicle performance envelope, wherein the computing system of the DBW vehicle platform is configured to restrict vehicle commands based on the set of performance limitations and ADAS, wherein the API is configured to provide feedback to the driver system comprising:
advisory values for each of the operational limits; and
control restriction alerts.

7. The vehicle system of claim 1, wherein set of the resource connections comprises redundant power and data connections.

8. The vehicle system of claim 1, wherein the set of resource connections comprises:
a first fluid manifold defining a first set of fluid ports, the DBW vehicle platform configured to circulate a chilled working fluid through the first set of fluid ports;
a set of electrical terminals electrically connected to vehicle power source of the DBW vehicle platform; and
a set of structural mounts.

9. The vehicle system of claim 8, wherein the set of structural mounts comprises a first set of mounts enclosed within an interior of the DBW vehicle platform and a second set of mounts at a vehicle exterior, wherein the set of resource connections further comprises a set of data channels extending between a first end, proximal to the first set of mounts, and a second end, proximal to the second set of mounts.

10. The vehicle system of claim 9, wherein the set of resource connections further comprises a second fluid manifold housing a cleaning agent and defining a second set of ports proximal to the second end.

11. The vehicle system of claim 8, further comprising an enclosure within the DBW vehicle platform, wherein the first set of fluid ports, the set of electrical terminals, and the set of structural mounts is arranged within the enclosure.

12. The vehicle system of claim 11, wherein the enclosure is vibration-damped relative to a vehicle body of the DBW vehicle platform.

13. The vehicle system of claim 8, further comprising a memory system which is separate from the driver system and housed within an impact-resistant enclosure, wherein the set of driver inputs and the feedback provided to the driver system are logged within the memory system.

14. The vehicle system of claim 1, wherein the API is integrated into a central computer of the computing system.

15. The vehicle system of claim 1, wherein the low-level communication network is configured to operate with a first communication protocol, wherein the API is configured to receive driver inputs under a second communication protocol which is different from the first communication protocol.

16. The vehicle system of claim 1, wherein the set of driver inputs are independent of an architecture of the low-level communication network.

17. A method for a Drive-by-Wire (DBW) vehicle comprising: a computing system; a plurality of vehicle systems; and a communication network connecting the computing system to the plurality of vehicle systems, the method comprising:
providing a set of vehicle resources within an enclosure of the DBW vehicle configured to house a modular autonomous agent, the set of resources comprising:
a power connection coupled to a power source of the DBW vehicle platform;
a cooling connection coupled to an onboard thermal management system of the DBW vehicle platform;
a data connection communicatively coupled with an Application Program Interface (API) of the computing system; and
a set of mounts coupled to the enclosure;
at the API, receiving a set of inputs from the modular autonomous agent via the data connection, the inputs received with a first communication protocol;
with the API, transforming the set of inputs into a set of vehicle commands and providing the set of vehicle commands to the computing system;
based on a first model associated with the communication network, distributing vehicle control instructions, based on the vehicle commands, to the plurality of vehicle systems via the communication network; and
determining feedback for the modular autonomous agent and providing the feedback to the modular autonomous agent via the API, the feedback comprising:
a vehicle state comprising values for a set of vehicle state parameters; and
a set of dynamic operational restrictions associated with the vehicle state.

18. The method of claim 17, wherein the communication network is decoupled from the modular autonomous agent, wherein the communication network uses a second communication protocol which is different from the first communication protocol.

19. The method of claim 17, further comprising: updating the first model without modification to the first communication protocol and without modification to a driver-side portion of the API.

20. The method of claim 17, wherein the modular autonomous agent is independent of the first model.
